(19) United States
(12) Patent Application Publication
(10) Pub. No.: US 2026/0101259 A1
(43) Pub. Date: Apr. 9, 2026

(54) SYSTEM AND METHOD FOR INDIRECT MULTI-CARRIER PROFILE MANAGEMENT

(71) Applicant: ITRON, INC., Liberty Lake, WA (US)

(72) Inventor: Oleg PACHKOVETS, Austin, TX (US)

(21) Appl. No.: 18/906,990

(22) Filed: Oct. 4, 2024

(51) Int. Cl. H04W 36/30; H04W 8/20

(52) U.S. Cl. CPC H04W 36/30; H04W 8/205

(57) ABSTRACT

Various embodiments disclose a multi-carrier connectivity management service that receives, from a number of carrier networks, network performance data for a subscriber identity module of an endpoint device. The multi-carrier connectivity management service analyzes the network performance data according to one or more connectivity performance criteria to identify a selected carrier network for the device to use. The multi-carrier connectivity management service causes the device to use the selected carrier network by transmitting a suspend command to one or more carrier networks other than the selected carrier network.

### BACKGROUND

### Field of the Various Embodiments

The various embodiments relate generally to communications networks, and more specifically, to indirect multi-carrier profile management.

### Description of the Related Art

Many enterprises can manage a large number of remote devices. For example, enterprises that control and/or monitor large infrastructure systems (e.g., power, water, traffic control, and the like) can include many thousands of devices (e.g., valves, metering devices, controllers, and the like). Generally, each device reports metrology data to one or more endpoint infrastructure management systems, which are tasked with coordinating the operation of the devices. Devices are often deployed in the field so that they communicate with endpoint infrastructure management systems over different networks that are operated by different network providers. These different networks can provide connectivity using different towers, different transport protocols and security requirements. As a result, connectivity, outages, speed, latency, and other network parameters can differ from network to network.

### BRIEF DESCRIPTION OF THE DRAWINGS

So that the manner in which the features of the various embodiments can be understood in detail, a description of the inventive concepts may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual diagram of a network environment for a multi-carrier connectivity management service, according to various embodiments.

FIG. 2 illustrates an example computing environment for the multi-carrier connectivity management service, according to various embodiments.

FIG. 3A illustrates an example of an endpoint device, according to various embodiments.

FIG. 3B illustrates another example of an endpoint device, according to various embodiments.

FIG. 4 illustrates a flow diagram of method steps for the multi-carrier connectivity management service to cause an endpoint device to use a selected carrier network, according to various embodiments.

FIG. 5 illustrates a flow diagram of method steps for a multi-carrier subscriber identity module (SIM) to switch carrier profiles, according to various embodiments.

FIG. 6 illustrates a flow diagram of method steps for an endpoint device to instruct a multi-carrier SIM to switch carrier profiles, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

Many enterprises deploy large numbers of endpoint devices, such as power meters, water meters, street light controllers, traffic controllers, and the like, to back-office management systems that monitor and/or control the endpoint devices. To deploy meters and other endpoint devices over a large geographic area, various carrier networks operated by different network providers under different access conditions are utilized. In many cases the endpoint devices include a single SIM having multiple carrier profiles that enable communications using multiple different carrier networks.

Different carrier networks can provide connectivity using different towers, different transport protocols, security requirements, and the like. As a result, connectivity, outages, speed, latency, and other carrier network parameters can differ from network to network. While the enterprise can use the same set of carrier networks for all endpoint devices, different multi-carrier SIM (and endpoint devices) can alternatively enable connectivity using a SIM-specific set of carrier networks. As the deployment integrates additional endpoint devices, additional carrier networks are often utilized. Accordingly, a given enterprise is tasked with managing connectivity for a large network of endpoint devices deployed across a heterogeneous network served by multiple different carrier networks.

Enterprises often desire to use a particular carrier based on connectivity, costs, and other considerations such as reliability, congestion, and the like. A typical endpoint device management system would require directly communicating an instruction to the endpoint device to use a selected carrier. For example, typical endpoint device management systems generally manage connectivity by retrieving network performance parameters from each endpoint device, assessing the performance parameters, and transmitting network selections (e.g., carrier network switching commands) to the endpoint devices. However, this approach utilizes significant bandwidth and power in each of the endpoint devices, because the endpoint device receives network performance parameter requests, transmits network performance parameters, and receives network selections many times over a long duration. The traditional approach also requires the endpoint device management systems to register and store communications data for each endpoint device. Ingesting and storing this communication information can be costly in time and resources.

To address these deficiencies, a multi-carrier connectivity management service manages carrier profiles on a multi-carrier SIM by communicating with carrier network application programming interfaces (APIs) or other carrier management interfaces to suspend (and resume) communications with the multi-carrier SIM at the carrier level. This causes the carrier to suspend (and resume) communications with the multi-carrier SIM. The endpoint device, or the multi-carrier SIM on the endpoint device, includes instructions that automatically switch to an available carrier (e.g., the selected carrier). The multi-carrier connectivity management service can store less data for each endpoint device or multi-carrier SIM. For example, the multi-carrier connectivity management service does not have to store communications data because the multi-carrier connectivity management service does not communicate with the endpoint devices directly. The multi-carrier connectivity management service also reduces bandwidth usage and power consumption of endpoint devices because the multi-carrier connectivity management service does not communicate with the endpoint devices directly.

The multi-carrier connectivity management service retrieves, using the carrier network interfaces, network performance information for each multi-carrier SIM. The multi-carrier connectivity management service assesses the performance information to identify which carrier network to utilize. For example, a network performance assessment can identify a selected carrier network and one or more carrier networks that are underperforming relative to the desired carrier network. The selected carrier network has a higher network performance relative to each of the one or more underperforming carrier networks. The multi-carrier connectivity management service uses carrier management interfaces of the carrier networks to suspend the relevant endpoint devices from using the one or more underperforming carrier networks, and resumes or activates the relevant endpoint devices with respect to the selected carrier network. When the endpoint device attempts to establish a connection using a carrier profile of a carrier network for which the endpoint device is suspended, the endpoint device will receive an error code. The error code triggers the carrier profile management agent of the endpoint device to switch to a carrier profile of a carrier network for which the endpoint device is enabled (e.g., resumed). This process ensures seamless connectivity of the endpoint device through a carrier switching process without any direct communications from the multi-carrier connectivity management service to the endpoint devices, and without any explicit command to the endpoint devices to use the selected carrier.

At least one technical advantage of the disclosed techniques is that the disclosed techniques reduce endpoint device bandwidth and power resource usage. As new endpoint devices are deployed, the disclosed techniques reduce time, processing, and storage resources relative to existing technologies. Additionally, the disclosed techniques reduce data storage and bandwidth resource usage of the multi-carrier connectivity management service.

### Networked Environment

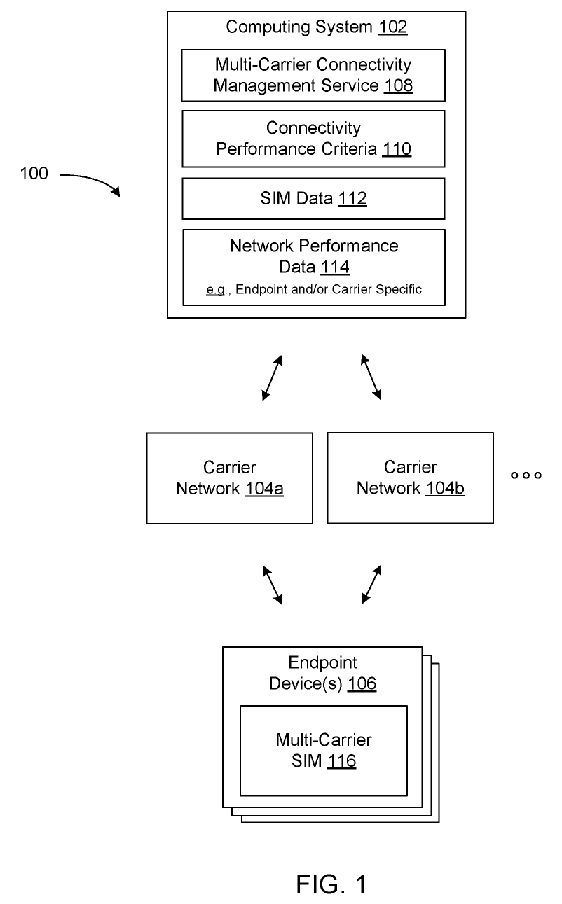

FIG. 1 is a conceptual diagram of the operation of a networked environment 100 that includes, without limitation, a computing system 102, carrier networks 104a and 104b (carrier networks 104), and one or more endpoint devices 106. The computing system 102 includes, without limitation, a multi-carrier connectivity management service 108, connectivity performance criteria 110, SIM data 112, and network performance data 114. Each endpoint device 106 includes, without limitation, a multi-carrier SIM 116.

Computing system 102 represents one or more computing devices, services, or systems through which the multi-carrier connectivity management service 108 communicates with carrier networks 104. The computing system 102 uses one or more processors to execute the multi-carrier connectivity management service 108. The computing system 102 uses one or more storages devices to store instructions including the multi-carrier connectivity management service 108 as well as connectivity performance criteria 110, SIM data 112, and network performance data 114.

The carrier network 104a provides a cellular or other type of wide area network. The carrier network 104a includes, without limitation, one or more base stations, one or more network devices such as routers, switches, and gateways, one or more radio communications devices, and so on. The carrier network 104a provides one or more carrier management interfaces such as APIs. Carrier management interfaces of the carrier network 104a provide the ability to activate, deactivate, suspend, and resume communications between the carrier network 104a and individual SIMs using corresponding carrier management commands. The individual SIMs are identified according to a SIM identifier. The SIM identifier refers to an International Mobile Subscriber Identity (IMSI) number or another identifier that uniquely identifies a particular SIM such as one of the multi-carrier SIMs 116.

The carrier network 104b provides a cellular or other type of wide area network. The carrier network 104b includes, without limitation, one or more base stations, one or more network devices such as routers, switches, and gateways, one or more radio communications devices, and so on. The carrier network 104b provides one or more carrier management interfaces such as APIs. Carrier management interfaces of the carrier network 104b provide the ability to activate, deactivate, suspend, and resume communications between the carrier network 104a and individual SIMs, according to a SIM identifier.

The multi-carrier connectivity management service 108 manages connectivity of the various endpoint devices 106 indirectly, by communicating with two or more carrier networks 104 including, without limitation, carrier network 104a and carrier network 104b. The multi-carrier connectivity management service 108 manages one or more multi-carrier SIMs 116 corresponding to endpoint devices 106. The multi-carrier connectivity management service 108 registers one or more multi-carrier SIMs 116 by storing limited amount of information about the multi-carrier SIMs 116. For example, the multi-carrier connectivity management service 108 registers a multi-carrier SIM 116 without storing communications information for direct communications with the endpoint device 106 and/or the multi-carrier SIM 116. However, the multi-carrier connectivity management service 108 can store data that includes, or is limited to, storing a SIM identifier and/or one or more carrier identifiers as SIM data 112. As a result, the multi-carrier connectivity management service 108 reduces storage resource usage relative to previous technologies. In examples where all multi-carrier SIMs 116 use the same set of carrier networks 104, the SIM data 112 a particular endpoint 106 can be limited to the SIM identifier. However, other information can also be stored, including a location, region, endpoint deployment group, or other data of the particular endpoint 106. Because the multi-carrier connectivity management service 108 does not transmit communications addressed to the endpoint devices 106, communication directing data is not stored.

The multi-carrier connectivity management service 108 receives network performance data 114 relevant to a multi-carrier SIM 116 of an endpoint device 106. The multi-carrier connectivity management service 108 retrieves and/or receives network performance data 114 from two or more carrier networks 104. In various examples, the network performance data 114 includes, without limitation, network-level performance information for a particular carrier network 104 supported by the multi-carrier SIM 116, region-level performance information specific to a region where the multi-carrier SIM 116 (and endpoint device 106) is located, and/or SIM-level information specific to the multi-carrier SIM 116. The multi-carrier connectivity management service 108 selects selected carrier network 104 from the two or more carrier networks 104 based on the network performance data 114 and one or more connectivity performance criteria 110. The multi-carrier connectivity management service 108 causes the endpoint device 106 to use the selected carrier network 104 indirectly, by transmitting a suspend command to one or more carrier networks 104 of the two or more carrier networks 104, other than the selected carrier network 104.

In an example where the two or more carrier networks 104 refer to the carrier network 104a and carrier network 104b, the multi-carrier connectivity management service 108 receives network performance data 114 for the multi-carrier SIM 116 from carrier network 104a and carrier network 104b. In this example, the multi-carrier connectivity management service 108 selects the carrier network 104a based on the connectivity performance criteria 110 and the network performance data 114. The multi-carrier connectivity management service 108 causes the endpoint device 106 to use the carrier network 104a indirectly, by transmitting a suspend command to the carrier network 104b. Because the carrier network 104b suspends communications with the multi-carrier SIM 116 using the suspend command, the endpoint device 106 receives a connectivity error with respect to the carrier network 104b. The endpoint device 106, and/or the multi-carrier SIM 116 itself, includes instructions that automatically switch to an available carrier network 104 in response to connectivity errors. In examples where the carrier network 104a is suspended at the time a carrier selection decision is made, the multi-carrier connectivity management service 108 also transmits a resume command to the carrier network 104a, so that the selected carrier network 104a is available to the endpoint device 106. Because the carrier network 104a is the only remaining available carrier network 104, the multi-carrier connectivity management service 108 thereby causes the endpoint device 106 to use the carrier network 104a indirectly.

### Computing Device

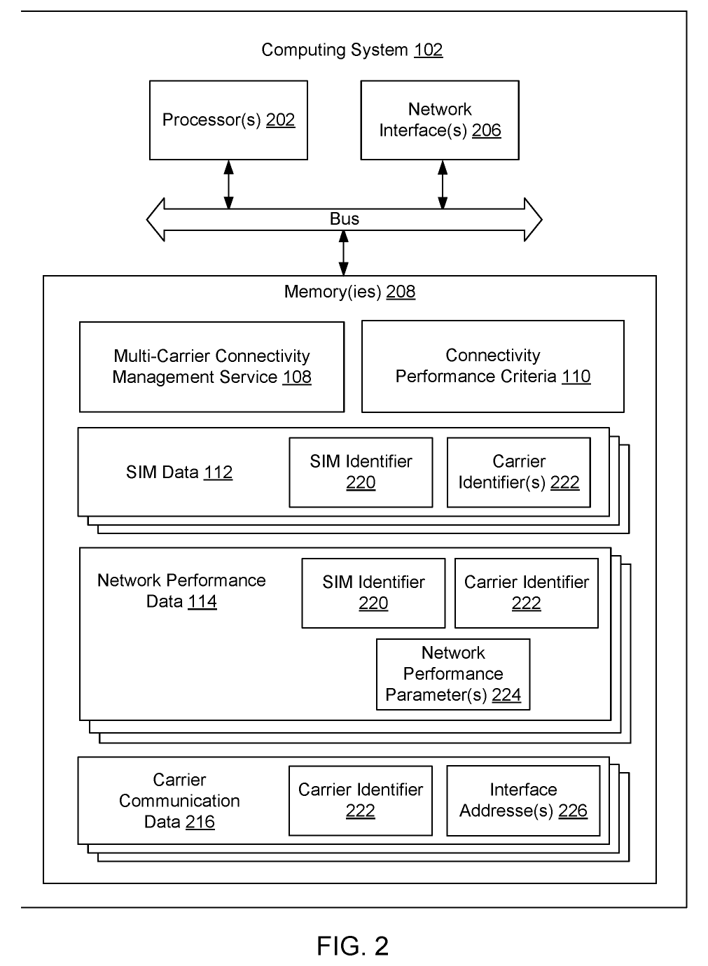

FIG. 2 illustrates a more detailed view of the computing system 102, according to various embodiments. In some embodiments the computing system 102 includes a computing device, such as a backend server, or some other computing device, located at an office or other facility of a utility provider. In some embodiments, the computing system 102 is implemented as a cluster of computing devices. As shown, the computing system 102 includes, without limitation, one or more processors 202, one or more network interfaces 206, and one or more memories 208, coupled together. A memory 208 includes, without limitation, a multi-carrier connectivity management service 108, connectivity performance criteria 110, SIM data 112, network performance data 114, and carrier communication data 216. The SIM data 112 includes, without limitation, one or more SIM identifiers 220 and one or more carrier identifiers 222. Network performance data 114 includes, without limitation, one or more SIM identifiers 220, one or more carrier identifiers 222, and values for one or more network performance parameters 224. Carrier communication data 216 includes, without limitation, one or more carrier identifiers 222 and one or more interface addresses 226 corresponding to carrier management interfaces.

The one or more processors 202 coordinate operations of the computing system 102. In various embodiments, processor 202 includes any hardware configured to process data and execute software applications. The processor 202 can be any technically feasible processing device configured to process data and execute program instructions. For example, processor 202 could include one or more CPUs, DSPs, GPUs, ASICs, FPGAs, microprocessors, microcontrollers, other types of processing units, and/or a combination of different processing units.

The one or more network interfaces 206 include devices configured to receive input, devices configured to provide output, and devices configured to both receive input and provide output. The one or more network interfaces 206 are configured to receive data and/or transmit data to and from devices providing the carrier networks 104 and/or other service providers.

Memory 208 can include any technically feasible storage device, such as a random-access memory (RAM) module, a flash memory unit, a hard disk drive, non-volatile storage, or any other type of memory unit or combination thereof. Memory 208 is shown storing executable components of a multi-carrier connectivity management service 108 as well as data including connectivity performance criteria 110, SIM data 112, network performance data 114, and carrier communication data 216.

The multi-carrier connectivity management service 108 manages connectivity of the various endpoint devices 106 indirectly, by communicating with two or more carrier networks 104. The multi-carrier connectivity management service 108 receives network performance data 114 from two or more carrier networks 104.

The connectivity performance criteria 110 refers to connectivity performance data such as metrics and/or functions that the multi-carrier connectivity management service 108 uses to assess network performance data 114. For example, connectivity performance criteria 110 includes weights for certain parameters of the network performance data 114, executable functions that utilize values for the parameters, relationships between the parameters, and so on. In an example where different carrier networks 104 provide different types of network performance data 114 (e.g., different parameters, different sets of parameters, and/or different formats), the connectivity performance criteria 110 includes multiple different carrier-specific criteria. The carrier-specific criteria output one or more values or metrics that enable the multi-carrier connectivity management service 108 to compare and rank the performance of a set of carrier networks 104 supported by a particular multi-carrier SIM 116 (see FIG. 1) of a corresponding endpoint device 106.

SIM data 112 includes information about one or more multi-carrier SIMs 116 of endpoint devices 106 that are deployed within a networked environment 100 (see FIG. 1). The SIM data 112 is shown as a number of SIM-specific data records. In the example shown, each SIM-specific data record includes a SIM identifier 220 and a set of carrier identifiers 222. The SIM identifier 220 can refer to an IMSI or another unique value that identifies a SIM among a population of SIMs. Where the multi-carrier SIM 116 is a device-integrated SIM, the SIM data 112 can alternatively be referred to as endpoint data. The SIM data 112 can also include a set of carrier identifiers 222 corresponding to carrier networks 104 that are supported by the multi-carrier SIM 116. Alternatively, the SIM data 112 can include a SIM group identifier that is used to identify carrier identifiers 222 of carrier networks 104 supported by a particular logical grouping of multi-carrier SIMs 116. In some examples, the SIM data 112 includes data indicating a region where the multi-carrier SIM 116 is expected to operate, a type of endpoint device 106 that the multi-carrier SIM 116 is installed or integrated with, and other data. However, the SIM data 112 does not need to include device communication information that enables the multi-carrier connectivity management service 108 to directly communicate with the endpoint device 106 or the multi-carrier SIM 116.

Network performance data 114 includes information that describes network performance for various carrier networks 104. The network performance data 114 is shown stored as being stored in association with both a SIM identifier 220 and a carrier identifier 222, such that a particular subset of the network performance parameters 224 is SIM-specific and/or carrier-specific. The network performance data 114 includes, without limitation, network-level performance information for a particular carrier network 104, region-level performance information specific to a region where the SIM (and endpoint device 106) is located, and/or SIM-level information specific to network performance of the multi-carrier SIM 116 (and endpoint device 106) in communications using the particular carrier network 104. In some examples, different carrier networks 104 provide different types of network performance data 114 including different parameters, different sets of parameters, and/or data different formats.

The carrier communication data 216 includes data that enables the multi-carrier connectivity management service 108 to instruct carrier networks 104 to perform SIM management actions including, without limitation, activate, deactivate, suspend, and resume actions using corresponding carrier management commands and/or requests. An activate command instructs a carrier network 104 to register a multi-carrier SIM 116 based on a SIM identifier 220. A deactivate command instructs a carrier network 104 to unregister a multi-carrier SIM 116 based on a SIM identifier 220. A suspend command instructs a carrier network 104 to disable or revoke communications with a multi-carrier SIM 116 based on a SIM identifier 220. The carrier network 104 disables or revokes communications with the multi-carrier SIM 116 until a resume command is received in association with the SIM identifier 220. The resume command instructs a carrier network 104 to enable or permit communications with a multi-carrier SIM 116 based on a SIM identifier 220. The carrier network 104 enables communications with the multi-carrier SIM until a suspend command is received in association with the SIM identifier 220. The carrier communication data 216 is shown as a number of carrier-specific data records. A particular carrier-specific data record includes, without limitation, a carrier identifier 222 for a carrier network 104, and one or more interface addresses 226 corresponding to carrier management interfaces (e.g., APIs and other programmatic interfaces) of the carrier network 104. In some examples, a single carrier management interface is used for all SIM management actions for the carrier network 104. In other examples, different management actions are invoked using different carrier management interfaces.

When executed by processor 202, the multi-carrier connectivity management service 108 manages connectivity of one or more multi-carrier SIMs 116. The multi-carrier connectivity management service 108 identifies and retrieves a SIM identifier 220 from a data store of memory 208.

The multi-carrier connectivity management service 108 identifies a set of carrier networks 104 supported by the multi-carrier SIM 116 corresponding to the SIM identifier 220. For example, the multi-carrier connectivity management service 108 uses the SIM identifier 220 as a key to retrieve a data record from the SIM data 112. The data record includes a set of carrier identifiers 222 that identifies the set of carrier networks 104 supported by the multi-carrier SIM 116.

For each of the supported carrier networks 104, the multi-carrier connectivity management service 108 transmits a request for network performance data 114 and/or parameters. The multi-carrier connectivity management service 108 transmits the request for network performance data 114 to invoke a carrier management interface that provides network performance data 114. The multi-carrier connectivity management service 108 identifies an interface address 226 indicated in the carrier communication data 216 for network performance data retrieval and transmits the request using the interface address 226. In some examples, a request for network performance data 114 includes the SIM identifier 220 as a parameter in an API call or interface call.

In response to the request for network performance data 114, the multi-carrier connectivity management service 108 receives network performance data 114 from the carrier network 104. The network performance data 114 includes values for network-level performance parameters, values for region-level performance parameters specific to a region where the multi-carrier SIM 116 is located, and/or SIM-level information specific to the SIM and endpoint device 106 itself. The multi-carrier connectivity management service 108 can retrieve network performance data 114 from the carrier networks 104 sequentially, concurrently, or with partial concurrence.

Once network performance data 114 is received from the set of carrier networks 104 supported by the multi-carrier SIM 116, the multi-carrier connectivity management service 108 selects a preferred or selected carrier network 104 for the multi-carrier SIM 116 to use. The multi-carrier connectivity management service 108 selects the preferred carrier network 104 based on the network performance data 114 and the connectivity performance criteria 110. The multi-carrier connectivity management service 108 processes the network performance data 114 using the connectivity performance criteria 110 to identify one or more network performance metric and ranks the carrier networks 104 based on the one or more performance metrics.

The multi-carrier connectivity management service 108 causes the endpoint device 106 to use the selected carrier network 104 indirectly, by transmitting a suspend command to one or more carrier networks 104 other than the selected carrier network 104. For a respective one of the carrier networks 104 other than the selected carrier network 104, the multi-carrier connectivity management service 108 transmits a suspend request in association with the SIM identifier 220. The multi-carrier connectivity management service 108 transmits the suspend command to invoke a carrier management interface that suspends connectivity. The suspend command includes the SIM identifier 220 as a parameter in an API call or interface call. The multi-carrier connectivity management service 108 transmits the suspend command to an interface address 226 indicated in the carrier communication data 216 for suspend commands.

In some examples, the multi-carrier connectivity management service 108 also transmits a resume command to the selected carrier network 104. The multi-carrier connectivity management service 108 transmits the resume command to invoke a carrier management interface that resumes connectivity for a specified multi-carrier SIM. To this end, the resume command includes the SIM identifier 220 as a parameter in an API call or interface call. The multi-carrier connectivity management service 108 transmits the resume command to an interface address 226 indicated in the carrier communication data 216 for resume commands.

### Endpoint Devices

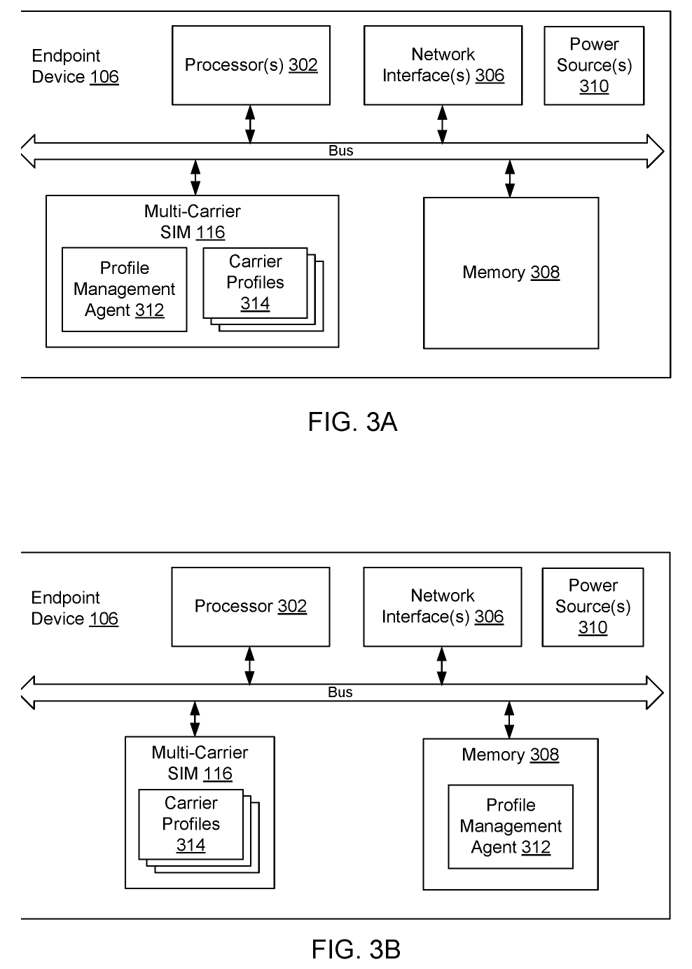

FIG. 3A illustrates a more detailed view of an endpoint device 106, according to various embodiments. In some embodiments the endpoint device 106 includes a computing device such as a controller, a personal computer device, a mobile device, or another type of computing device. The endpoint device 106 can include a power meter, water meter, traffic controller, or another type of device that provides data to back-office management systems that monitor and/or control a number of endpoint devices 106. The endpoint device 106 includes, without limitation, a multi-carrier SIM 116, one or more processors 302, one or more network interfaces 306, one or more memories 308, and one or more power sources 310. The multi-carrier SIM 116 includes, without limitation, a profile management agent 312 and two or more carrier profiles 314.

The one or more processors 302 coordinate operations of the computing system 102. In various embodiments, processor 302 includes any hardware configured to process data and execute software applications. The processor 302 can be any technically feasible processing device configured to process data and execute program instructions. For example, processor 302 could include one or more CPUs, DSPs, GPUs, ASICs, FPGAs, microprocessors, microcontrollers, other types of processing units, and/or a combination of different processing units.

The one or more network interfaces 306 include devices configured to receive input, devices configured to provide output, and devices configured to both receive input and provide output. The one or more network interfaces 306 are configured to receive data and/or transmit data to and from devices providing the carrier networks 104 (see FIG. 1) and/or other service providers.

Memory 308 can include any technically feasible storage device, such as a random-access memory (RAM) module, a flash memory unit, a hard disk drive, non-volatile storage, or any other type of memory unit or combination thereof.

A power source 310 includes any source of power capable of energizing the endpoint device 106. In some examples, a power source 310 couples the endpoint device 106 to power from an electrical power grid such as an electrical outlet. In some examples, a power source 310 includes one or more energy storage devices such as batteries, fuel cells, and so on. In some examples, a power source 310 includes energy harvesting components such as solar harvesting components, vibration and other motion energy harvesting components, and so on.

The multi-carrier SIM 116 includes any SIM that enables communication with multiple carrier networks 104. The multi-carrier SIM 116 can refer to a removable SIM or a device integrated SIM such as an eSIM or an iSIM. Various examples of the multi-carrier SIM 116 include an integrated circuit located on a removable SIM card, an integrated circuit component that is permanently installed to the endpoint device 106, or a software SIM stored by a component of the endpoint device 106. The multi-carrier SIM 116 includes two or more carrier profiles 314 corresponding to two or more carrier networks 104. The multi-carrier SIM 116 in the shown example also includes a profile management agent 312.

The profile management agent 312 is configured to switch between the various carrier profiles 314 according to profile management logic. In some examples, the profile management agent 312 is executed using an integrated circuit or other processor of the multi-carrier SIM 116. The profile management agent 312 includes a ranked listing of the carrier profiles 314. The profile management agent 312 detects whether a currently enabled or utilized carrier profile 314 is operational or associated with an error state. If the current carrier profile 314 is operational (and/or no error state is detected), the profile management agent 312 continues to use the currently used carrier profile 314. However, if an error state is received and/or detected in association with an attempt to utilize the currently used carrier profile 314, the profile management agent 312 attempts to utilize a next carrier profile 314 in the ranked listing. The profile management agent 312 continues to connect to carrier networks 104 using the various carrier profiles 314 until the profile management agent 312 identifies that a carrier profile 314 enables the endpoint device 106 to successfully communicate using a corresponding carrier network 104. The profile management agent 312 identifies that a carrier profile 314 enables successful communication if data is successfully transferred and/or if no error state is detected.

The profile management agent 312 enables the multi-carrier connectivity management service 108 to influence the carrier selection of the endpoint device 106 indirectly. For example, if the multi-carrier connectivity management service 108 transmits a suspend command to unselected carrier networks 104 (e.g., carrier networks 104 other than the selected carrier network 104), the profile management agent 312 detects an error state when attempting to connect to the unselected carrier networks 104 using the corresponding carrier profiles 314. However, the profile management agent 312 identifies or detects a successful connection when connecting to the selected carrier network 104 using the corresponding carrier profile 314. As a result, the profile management agent 312 automatically switches to the selected carrier network 104 based on the indirect operations of the multi-carrier connectivity management service 108.

FIG. 3B illustrates a more detailed view of an endpoint device 106, according to various embodiments. In some embodiments the endpoint device 106 includes a computing device such as a controller, a personal computer device, a mobile device, or another type of computing device. The endpoint device 106 can include a power meter, water meter, traffic controller, or another type of device that provides data to back-office management systems that monitor and/or control a number of endpoint devices 106. The endpoint device 106 includes, without limitation, a multi-carrier SIM 116, one or more processors 302, one or more network interfaces 306, one or more memories 308, and one or more power sources 310. In this Figure, the multi-carrier SIM 116 includes, without limitation, two or more carrier profiles 314. In this Figure, the one or more memories 308 include, without limitation, a profile management agent 312.

The one or more processors 302 coordinate operations of the computing system 102. In various embodiments, processor 302 includes any hardware configured to process data and execute software applications. The processor 302 can be any technically feasible processing device configured to process data and execute program instructions. For example, processor 302 could include one or more CPUs, DSPs, GPUs, ASICs, FPGAs, microprocessors, microcontrollers, other types of processing units, and/or a combination of different processing units.

The one or more network interfaces 306 include devices configured to receive input, devices configured to provide output, and devices configured to both receive input and provide output. The one or more network interfaces 306 are configured to receive data and/or transmit data to and from devices providing the carrier networks 104 (see FIG. 1) and/or other service providers.

Memory 308 can include any technically feasible storage device, such as a random-access memory (RAM) module, a flash memory unit, a hard disk drive, non-volatile storage, or any other type of memory unit or combination thereof. In this example, memory 308 stores the profile management agent 312.

A power source 310 includes any source of power capable of energizing the endpoint device 106. In some examples, a power source 310 couples the endpoint device 106 to power from an electrical power grid such as an electrical outlet. In some examples, a power source 310 includes one or more energy storage devices such as batteries, fuel cells, and so on. In some examples, a power source 310 includes energy harvesting components such as solar harvesting components, vibration and other motion energy harvesting components, and so on.

The multi-carrier SIM 116 includes any SIM that enables communication with multiple carrier networks 104. The multi-carrier SIM 116 can refer to a removable SIM or a device integrated SIM such as an eSIM or an iSIM. Various examples of the multi-carrier SIM 116 include an integrated circuit located on a removable SIM card, an integrated circuit component that is permanently installed to the endpoint device 106, or a software SIM stored by a component of the endpoint device 106. The multi-carrier SIM 116 includes two or more carrier profiles 314 corresponding to two or more carrier networks 104. The multi-carrier SIM 116 in the shown example also includes a profile management agent 312.

The profile management agent 312 is configured to transmit commands for the multi-carrier SIM 116 to switch between the various carrier profiles 314 according to profile management logic. Some examples of the profile management agent 312 include a ranked listing of the carrier profiles 314. The profile management agent 312 detects whether a currently utilized carrier profile 314 is operational or associated with an error state. If the currently utilized carrier profile 314 is operational (and/or no error state is detected), the profile management agent 312 continues to use the currently utilized carrier profile 314. However, if an error state is received and/or detected in association with an attempt to utilize the currently utilized carrier profile 314, the profile management agent 312 transmits a command for the multi-carrier SIM 116 to utilize a next carrier profile 314 in the ranked listing, until the profile management agent 312 identifies that a carrier profile 314 enables the endpoint device 106 to successfully communicate using a corresponding carrier network 104. The profile management agent 312 identifies that a carrier profile 314 enables successful communication if data is successfully transferred and/or if no error state is detected.

The profile management agent 312 enables the multi-carrier connectivity management service 108 to influence carrier selection of the endpoint device 106 indirectly. For example, if the multi-carrier connectivity management service 108 transmits a suspend command to unselected carrier networks 104 (e.g., carrier networks 104 other than the selected carrier network 104), the profile management agent 312 detects an error state when attempting to connect to the unselected carrier networks 104 using the corresponding carrier profiles 314. However, the profile management agent 312 identifies or detects a successful connection when connecting to the selected carrier network 104 using the corresponding carrier profile 314. As a result, the profile management agent 312 automatically switches to the selected carrier network 104 based on the indirect operations of the multi-carrier connectivity management service 108.

### Selecting Carrier Networks for Multi-Carrier SIMs

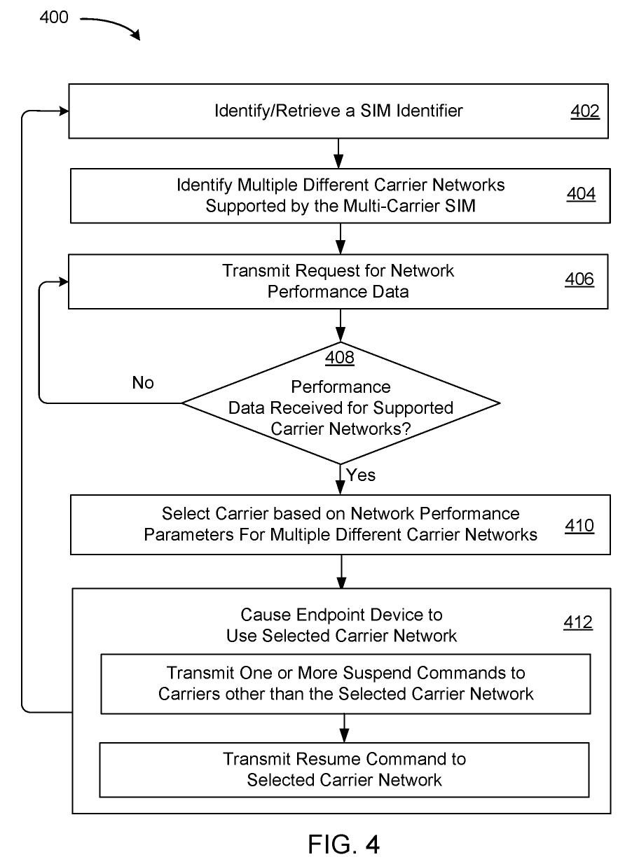

FIG. 4 is a flow diagram of method steps for the multi-carrier connectivity management service 108 to cause an endpoint device 106 to use a selected carrier network 104, according to various embodiments. Although the method steps are shown in an order, persons skilled in the art will understand that some method steps may be performed in a different order, repeated, omitted, and/or performed by components other than those described in FIG. 4. Although the method steps are described with respect to the systems of FIGS. 1-3B, persons skilled in the art will understand that any system configured to perform the method steps, in any order, falls within the scope of the various embodiments.

As shown, a method 400 begins at step 402, where the multi-carrier connectivity management service 108 identifies and/or retrieves a SIM identifier 220. The multi-carrier connectivity management service 108 retrieves stores, in memory 208, a set of SIM identifiers 220 corresponding to multi-carrier SIMs 116 that are managed by the multi-carrier connectivity management service 108. The multi-carrier connectivity management service 108 retrieves the SIM identifier 220 from a data store of memory 208.

At step 404, the multi-carrier connectivity management service 108 identifies a set of carrier networks 104 supported by the multi-carrier SIM 116 corresponding to the SIM identifier 220. For example, the multi-carrier connectivity management service 108 uses the SIM identifier 220 as a key to retrieve a data record from the SIM data 112. The data record includes a set of carrier identifiers 222 corresponding to the set of carrier networks 104 supported by the multi-carrier SIM 116.

At step 406, the multi-carrier connectivity management service 108 transmits a request for network performance data 114. The multi-carrier connectivity management service 108 transmits the request for network performance data 114 to invoke a carrier management interface. The multi-carrier connectivity management service 108 identifies an interface address 226 indicated in the carrier communication data 216 for network performance data retrieval and transmits the request using the interface address 226. In some examples, the request for network performance data 114 includes the SIM identifier 220 as a parameter in an API call or interface call. In response to the request, the multi-carrier connectivity management service 108 receives at least a subset of the network performance data 114. The network performance data 114 includes values for network-level performance parameters, values for region-level performance parameters specific to a region where the multi-carrier SIM 116 is located, and/or SIM-level information specific to the SIM and endpoint device 106 itself.

At step 408, the multi-carrier connectivity management service 108 determines whether network performance data 114 is received for the carrier networks 104 supported by the multi-carrier SIM 116. If the carrier connectivity management service 108 has received network performance data 114 for the set of carrier networks 104 supported by the multi-carrier SIM 116, the multi-carrier connectivity management service 108 moves to step 410. Otherwise, the multi-carrier connectivity management service 108 moves to step 406 and transmits one or more additional requests to retrieve network performance data 114 from one or more additional carrier networks 104.

At step 410, the multi-carrier connectivity management service 108 selects a carrier network 104 for the multi-carrier SIM 116 to use. The multi-carrier connectivity management service 108 selects the preferred or ‘selected’ carrier network 104 based on the network performance data 114 and the connectivity performance criteria 110. The multi-carrier connectivity management service 108 processes the network performance data 114 using the connectivity performance criteria 110 to identify one or more network performance metric and ranks the carrier networks 104 based on the one or more performance metrics.

At step 412, the multi-carrier connectivity management service 108 causes the endpoint device 106 to use the selected carrier network 104 indirectly. In some examples, the multi-carrier connectivity management service 108 transmits a suspend command to one or more carrier networks 104 other than the selected carrier network 104. For a respective one of the carrier networks 104 other than the selected carrier network 104, the multi-carrier connectivity management service 108 transmits a suspend request. The suspend command includes the SIM identifier 220 as a parameter in an API call or interface call. The multi-carrier connectivity management service 108 transmits the suspend command to an interface address 226 indicated in the carrier communication data 216 for suspend commands.

In some examples, the multi-carrier connectivity management service 108 transmits a resume command the selected carrier network 104. The multi-carrier connectivity management service 108 transmits the resume command to invoke a carrier management interface that resumes connectivity for a specified multi-carrier SIM. To this end, the resume command includes the SIM identifier 220 as a parameter in an API call or interface call. The multi-carrier connectivity management service 108 transmits the resume command to an interface address 226 indicated in the carrier communication data 216 for resume commands. Thereafter, the multi-carrier connectivity management service 108 proceeds to step 402 and repeats the method 400 for another SIM identifier 220.

### Endpoint Device Carrier Profile Switching

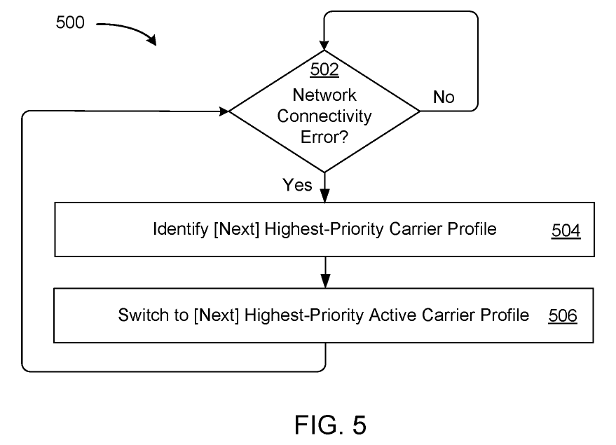

FIG. 5 illustrates a flow diagram of method steps for a multi-carrier SIM 116 to switch carrier profiles 314, according to various embodiments. Although the method steps are shown in an order, persons skilled in the art will understand that some method steps may be performed in a different order, repeated, omitted, and/or performed by components other than those described in FIG. 5. Although the method steps are described with respect to the systems of FIGS. 1-3B, persons skilled in the art will understand that any system configured to perform the method steps, in any order, falls within the scope of the various embodiments.

As shown, a method 500 begins at step 502, where the profile management agent 312 determines whether a network connectivity error is received or detected. The multi-carrier SIM 116 executes a profile management agent 312 configured to switch between the various carrier profiles 314 according to profile management logic. The profile management agent 312 enables the multi-carrier connectivity management service 108 to influence the carrier selection of the endpoint device 106 indirectly. For example, if the multi-carrier connectivity management service 108 transmits a suspend command to a currently utilized carrier network 104, the profile management agent 312 detects an error state when attempting to connect to the unselected carrier networks 104 using the corresponding carrier profiles 314. The profile management agent 312 continues to use a current carrier profile 314 for a corresponding carrier network 104 until a network connectivity error is identified. For example, if the currently utilized carrier profile 314 is operational (and/or no error state is detected), the profile management agent 312 continues to use the currently utilized carrier profile 314. However, if a network connectivity error is received or detected, the multi-carrier SIM 116 moves to step 504.

At step 504, the profile management agent 312 identifies a [next] highest ranked carrier profile 314 other than the currently utilized carrier profile 314, which is associated with the error state. The carrier profile priority data includes a ranked listing of supported carrier profiles 314. If an error state is received or detected, the profile management agent 312 uses the ranked listing to identify a highest ranked or highest priority carrier profile 314, excluding the currently utilized carrier profile 314. Because the profile management agent 312 iteratively attempts the carrier profile 314 according to the ranking, the profile management agent 312 also excludes recently attempted carrier profiles 314 that are associated with an error state within a predetermined time period.

At step 506, the profile management agent 312 switches carrier profiles 314 to the [next] highest ranked carrier profile 314 other than the currently utilized carrier profile 314. The profile management agent 312 then moves to step 502 and checks for any network connectivity errors. As a result, the profile management agent 312 attempts to connect to different carrier networks 104 using corresponding carrier profiles 314 from the ranked listing until a successful connection is identified. The profile management agent 312 identifies or detects a successful connection when connecting to the selected carrier network 104 using the corresponding carrier profile 314. As a result, the profile management agent 312 automatically switches to the selected carrier network 104 based on the indirect operations of the multi-carrier connectivity management service 108.

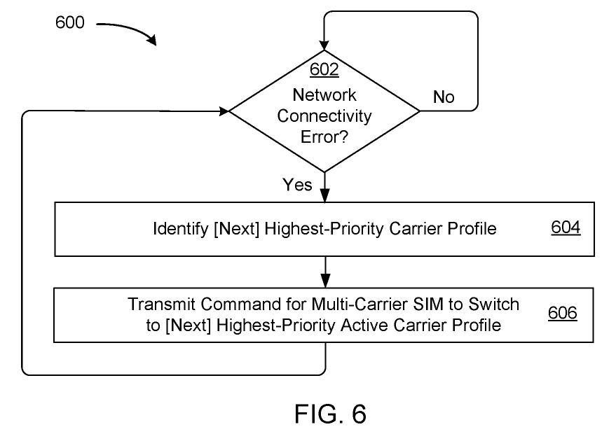

FIG. 6 illustrates a flow diagram of method steps for an endpoint device to instruct a multi-carrier SIM to switch carrier profiles, according to various embodiments. Although the method steps are shown in an order, persons skilled in the art will understand that some method steps may be performed in a different order, repeated, omitted, and/or performed by components other than those described in FIG. 6. Although the method steps are described with respect to the systems of FIGS. 1-3B, persons skilled in the art will understand that any system configured to perform the method steps, in any order, falls within the scope of the various embodiments.

As shown, a method 600 begins at step 602, where the profile management agent 312 determines whether a network connectivity error is received or detected. In this example, the endpoint device 106 executes the profile management agent 312 that switches between the various carrier profiles 314. The profile management agent 312 enables the multi-carrier connectivity management service 108 to influence the carrier selection of the endpoint device 106 indirectly. For example, if the multi-carrier connectivity management service 108 transmits a suspend command to a currently utilized carrier network 104, the profile management agent 312 detects an error state when attempting to connect to the unselected carrier networks 104 using the corresponding carrier profiles 314. The profile management agent 312 continues to use a current carrier profile 314 for a corresponding carrier network 104 until a network connectivity error is identified. For example, if the currently utilized carrier profile 314 is operational (and/or no error state is detected), the profile management agent 312 continues to use the currently utilized carrier profile 314. However, if a network connectivity error is received or detected, method 600 moves to step 604.

At step 604, the profile management agent 312 identifies a [next] highest ranked carrier profile 314 other than the currently utilized carrier profile 314, which is associated with the error state. The carrier profile priority data includes a ranked listing of supported carrier profiles 314. If an error state is received or detected, the profile management agent 312 uses the ranked listing to identify a highest ranked or highest priority carrier profile 314, excluding the currently utilized carrier profile 314. Because the profile management agent 312 iteratively attempts the carrier profile 314 according to the ranking, the profile management agent 312 also excludes recently attempted carrier profiles 314 that are associated with an error state within a predetermined time period.

At step 606, the profile management agent 312 transmits a command for the multi-carrier SIM 116 to switch carrier profiles 314 to the [next] highest ranked carrier profile 314 other than the currently utilized carrier profile 314. The profile management agent 312 then moves to step 602 and checks for any network connectivity errors. As a result, the profile management agent 312 transmits commands for the multi-carrier SIM 116 to use different carrier profiles 314 from the ranked listing until a successful connection is identified. The profile management agent 312 identifies or detects a successful connection when connecting to the selected carrier network 104 using the corresponding carrier profile 314. As a result, the profile management agent 312 automatically switches to the selected carrier network 104 based on the indirect operations of the multi-carrier connectivity management service 108.

In sum, techniques are disclosed herein that enable a multi-carrier connectivity management service to indirectly control carrier network selection duties for managed endpoint devices. According to various embodiments, a multi-carrier connectivity management service receives, from a number of carrier networks, network performance data for a subscriber identity module of an endpoint device. The multi-carrier connectivity management service analyzes the network performance data according to one or more connectivity performance criteria to identify a selected carrier network for the device to use. The multi-carrier connectivity management service causes the device to use the selected carrier network by transmitting a suspend command to one or more carrier networks other than the selected carrier network.

At least one technical advantage of the disclosed techniques is that the disclosed techniques reduce endpoint device bandwidth and power resource usage. As new endpoint devices are deployed, the disclosed techniques reduce time, processing, and storage resources relative to existing technologies. Additionally, the disclosed techniques reduce data storage and bandwidth resource usage of the multi-carrier connectivity management service.

The following clauses describe aspects of various embodiments.

1. In some embodiments, a method comprises receiving, by a multi-carrier connectivity management service, network performance data for a subscriber identity module (SIM) of an endpoint device, wherein the network performance data is received from a plurality of carrier networks, selecting, by the multi-carrier connectivity management service, a selected carrier network for the endpoint device to use based on the network performance data and one or more connectivity performance criteria, and causing, by the multi-carrier connectivity management service, the endpoint device to use the selected carrier network by transmitting a suspend command to one or more carrier networks of the plurality of carrier networks other than the selected carrier network.

2.The method of clause 1, wherein causing the endpoint device to use the selected carrier network further comprises transmitting a resume command to the selected carrier network.

3. The method of clauses 1 or 2, wherein the suspend command comprises a SIM identifier of the SIM.

4. The method of any of clauses 1-3, wherein the suspend command instructs at least one carrier network to suspend or disable communications with the SIM.

5. The method of any of clauses 1-4, wherein transmitting the suspend command comprises invoking an application programming interface (API) of at least one carrier network.

6. The method of any of clauses 1-5, wherein the network performance data is received in response to one or more requests transmitted to the plurality of carrier networks.

7. The method of any of clauses 1-6, wherein the network performance data comprises a plurality of different types of network performance parameters corresponding to respective ones of the plurality of carrier networks.

8. The method of any of clauses 1-7, wherein the one or more connectivity performance criteria comprise a plurality of different connectivity performance criteria, a respective connectivity performance criterion corresponding to a respective carrier network of the plurality of carrier networks.

9. The method of any of clauses 1-8, wherein the multi-carrier connectivity management service causes the endpoint device to use the selected carrier network without direct communications between the multi-carrier connectivity management service and the endpoint device.

10. The method of any of clauses 1-9, further comprising registering, by the multi-carrier connectivity management service, the SIM of the endpoint device without storing communications information for direct communications with the endpoint device.

11. The method of any of clauses 1-10, wherein the SIM is a device-integrated SIM comprising an embedded SIM (eSIM) or an integrated SIM (iSIM).

12. In some embodiments, one or more non-transitory computer-readable media store instructions which, when executed by one or more processors, cause the one or more processors to perform operations comprising identifying, by a multi-carrier connectivity management service, values for one or more network performance parameters for a plurality of carrier networks supported by subscriber identity module (SIM) of an endpoint device, selecting, by the multi-carrier connectivity management service, a desired carrier network for the endpoint device to use, wherein the desired carrier network is selected from the plurality of carrier networks based on the values for the network performance parameters and one or more connectivity performance metrics, and transmitting, by the multi-carrier connectivity management service, one or more suspend commands to one or more of the plurality of carrier networks other than the desired carrier network, wherein the one or more suspend commands indirectly cause the endpoint device to use the desired carrier network.

13. The one or more non-transitory computer-readable media of clause 12, wherein the operations further comprise transmitting a resume command to the desired carrier network, wherein the resume command and the one or more suspend commands indirectly cause the endpoint device to use the desired carrier network.

14. The one or more non-transitory computer-readable media of clauses 12 or 13, wherein the one or more suspend commands instruct at least one carrier network to disable communications with the endpoint device.

15. The one or more non-transitory computer-readable media of any of clauses 12-14, wherein the operations further comprise transmitting one or more network performance parameter requests to the plurality of carrier networks, wherein the values for the one or more network performance parameters are received in response to the one or more network performance parameter requests.

16. The one or more non-transitory computer-readable media of any of clauses 12-15, wherein the network performance parameters comprise a plurality of different sets of the network performance parameters corresponding to respective ones of the plurality of carrier networks, or the one or more connectivity performance metrics comprise a plurality of different connectivity performance metrics corresponding to the respective ones of the plurality of carrier networks.

17. In some embodiments, a computing system comprises one or more processors, and a memory storing executable instructions that, when executed by the one or more processors, cause the one or more processors to perform operations comprising retrieving, by a multi-carrier connectivity management service, network performance data for a plurality of carrier networks that can be accessed by a subscriber identity module (SIM) of an endpoint device, determining, by the multi-carrier connectivity management service, a desired carrier network from the plurality of carrier networks based on the network performance data and connectivity performance data, and transmitting one or more carrier management commands to one or more carrier networks of the plurality of carrier networks, thereby causing the endpoint device to communicate using the desired carrier network.

18. The computing system of clause 17, wherein transmitting one or more carrier management commands comprises at least one of transmitting one or more suspend commands to one or more of the plurality of carrier networks other than the desired carrier network, or transmitting a resume command to the desired carrier network.

19. The computing system of clauses 17 or 18, wherein the SIM includes a profile management agent that automatically switches to a carrier profile for an available carrier network in response to identifying an error state.

20. The computing system of any of clauses 17-19, wherein the endpoint device includes a profile management agent that automatically transmits a command for the SIM to switch to a carrier profile for an available carrier network in response to identifying an error state.

Any and all combinations of any of the claim elements recited in any of the claims and/or any elements described in this application, in any fashion, fall within the contemplated scope of the present protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable media having computer readable program code embodied thereon.

Any combination of one or more computer readable media can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow. Moreover, in the above description, numerous specific details are set forth to provide a more thorough understanding of the various embodiments. However, it will be apparent to one skilled in the art that the inventive concepts may be practiced without one or more of these specific details.

What is claimed is:

1. A method comprising:
receiving, by a multi-carrier connectivity management service, network performance data for a subscriber identity module (SIM) of an endpoint device, wherein the network performance data is received from a plurality of carrier networks;
selecting, by the multi-carrier connectivity management service, a selected carrier network for the endpoint device to use based on the network performance data and one or more connectivity performance criteria; and
causing, by the multi-carrier connectivity management service, the endpoint device to use the selected carrier network by:
transmitting a suspend command to one or more carrier networks of the plurality of carrier networks other than the selected carrier network.

2. The method of claim 1, wherein causing the endpoint device to use the selected carrier network further comprises:
transmitting a resume command to the selected carrier network.

3. The method of claim 1, wherein the suspend command comprises a SIM identifier of the SIM.

4. The method of claim 1, wherein the suspend command instructs at least one carrier network to suspend or disable communications with the SIM.

5. The method of claim 1, wherein transmitting the suspend command comprises invoking an application programming interface (API) of at least one carrier network.

6. The method of claim 1, wherein the network performance data is received in response to one or more requests transmitted to the plurality of carrier networks.

7. The method of claim 1, wherein the network performance data comprises a plurality of different types of network performance parameters corresponding to respective ones of the plurality of carrier networks.

8. The method of claim 1, wherein the one or more connectivity performance criteria comprise a plurality of different connectivity performance criteria, a respective connectivity performance criterion corresponding to a respective carrier network of the plurality of carrier networks.

9. The method of claim 1, wherein the multi-carrier connectivity management service causes the endpoint device to use the selected carrier network without direct communications between the multi-carrier connectivity management service and the endpoint device.

10. The method of claim 1, further comprising:
registering, by the multi-carrier connectivity management service, the SIM of the endpoint device without storing communications information for direct communications with the endpoint device.

11. The method of claim 1, wherein the SIM is a device-integrated SIM comprising an embedded SIM (eSIM) or an integrated SIM (iSIM).

12. One or more non-transitory computer-readable media storing instructions which, when executed by one or more processors, cause the one or more processors to perform operations comprising:
identifying, by a multi-carrier connectivity management service, values for one or more network performance parameters for a plurality of carrier networks supported by subscriber identity module (SIM) of an endpoint device;
selecting, by the multi-carrier connectivity management service, a desired carrier network for the endpoint device to use, wherein the desired carrier network is selected from the plurality of carrier networks based on the values for the network performance parameters and one or more connectivity performance metrics; and
transmitting, by the multi-carrier connectivity management service, one or more suspend commands to one or more of the plurality of carrier networks other than the desired carrier network, wherein the one or more suspend commands indirectly cause the endpoint device to use the desired carrier network.

13. The one or more non-transitory computer-readable media of claim 12, wherein the operations further comprise:
transmitting a resume command to the desired carrier network, wherein the resume command and the one or more suspend commands indirectly cause the endpoint device to use the desired carrier network.

14. The one or more non-transitory computer-readable media of claim 12, wherein the one or more suspend commands instruct at least one carrier network to disable communications with the endpoint device.

15. The one or more non-transitory computer-readable media of claim 12, wherein the operations further comprise:
transmitting one or more network performance parameter requests to the plurality of carrier networks, wherein the values for the one or more network performance parameters are received in response to the one or more network performance parameter requests.

16. The one or more non-transitory computer-readable media of claim 12, wherein:
the network performance parameters comprise a plurality of different sets of the network performance parameters corresponding to respective ones of the plurality of carrier networks, or
the one or more connectivity performance metrics comprise a plurality of different connectivity performance metrics corresponding to the respective ones of the plurality of carrier networks.

17. A computing system, comprising:
one or more processors; and
a memory storing executable instructions that, when executed by the one or more processors, cause the one or more processors to perform operations comprising:
retrieving, by a multi-carrier connectivity management service, network performance data for a plurality of carrier networks that can be accessed by a subscriber identity module (SIM) of an endpoint device;
determining, by the multi-carrier connectivity management service, a desired carrier network from the plurality of carrier networks based on the network performance data and connectivity performance data; and
transmitting one or more carrier management commands to one or more carrier networks of the plurality of carrier networks, thereby causing the endpoint device to communicate using the desired carrier network.

18. The computing system of claim 17, wherein transmitting one or more carrier management commands comprises at least one of:
transmitting one or more suspend commands to one or more of the plurality of carrier networks other than the desired carrier network, or
transmitting a resume command to the desired carrier network.

19. The computing system of claim 17, wherein the SIM includes a profile management agent that automatically switches to a carrier profile for an available carrier network in response to identifying an error state.

20. The computing system of claim 17, wherein the endpoint device includes a profile management agent that automatically transmits a command for the SIM to switch to a carrier profile for an available carrier network in response to identifying an error state.
